(19) United States
(12) Patent Application Publication
(10) Pub. No.: US 2010/0130042 A1
(43) Pub. Date: May 27, 2010

(54) CONNECTOR SOCKET, A CONNECTOR PLUG, AND AN APPLIANCE FITTED WITH A CONNECTOR

(76) Inventor: Jeremy Gray, New South Wales (AU)

Correspondence Address: WHITHAM, CURTIS & CHRISTOFFERSON & COOK, P.C., 11491 SUNSET HILLS ROAD, SUITE 340, RESTON, VA, 20190, US

(21) Appl. No.: 12/524,859

(22) PCT Filed: Jan. 11, 2008
(86) PCT No.: PCT/AU2008/000031

§ 371 Date: Nov. 19, 2009

(30) Foreign Application Priority Data
Feb. 1, 2007 (AU) 2007900479

(51) Int. Cl. H01R 29/00; H01R 25/00; H01R 13/02

(52) U.S. Cl. 439/176; 439/284; 439/225

(57) ABSTRACT

A socket (102) and plug (152) for an electrical connector arrangement are designed so that the contact blades (158) of the plug are elongate and oriented transverse to the body (154) of the plug and the direction of connexion is parallel to the plane of the blades and transverse to the major axis of the contact blades.

### FIELD OF THE INVENTION

This invention relates to electrical connectors.

The invention is applicable to electrical socket and plug arrangements generally and to appliances including connectors.

### BACKGROUND OF THE INVENTION

Electrical connectors usually include a socket member and a plug member. In many countries, power cable connectors have a three pin socket and plug to connect active, neutral and earth wires. However, special connectors may need to be designed to connect more than three wires. Generally the socket is wired to the building electrical supply, while the plug is attached to the appliance either directly or via a cable.

Most socket and plug arrangements are designed so that the connexion is made axially. The socket or plug may include contact blades having a major axis, and the socket and plug are adapted to mate in a direction parallel to the axis of the contact blades.

Connectors can also be bulky, and this can be a disadvantage where aesthetics is of concern as well as in, applications in which the appliance must be installed in a confined space.

Ceiling lights in office buildings are often installed in the false ceiling below an upper floor. These light fittings can have two or three power wires and one or more control wires connected to them.

Plug contacts usually have an elongate shape so a major axis is parallel to the longer dimension of the contact. This axial direction is the direction for plugging and unplugging the plug and socket. Where a plug is integrated into an appliance, the contacts of the plug are normally transverse to the wall of the appliance. This means that the plug extends for a distance transverse to the wall of the appliance so that it projects out from or into the appliance. This can cause problems, for example, where the internal space in the appliance is at a premium, or where it is desired to reduce the overall dimensions of the appliance.

### SUMMARY OF THE INVENTION

According to an embodiment of the invention, there is provided a plug having a receptacle adapted to receive a socket contacts, the receptacle including contact blades being adapted to receive socket contacts inserted transverse to the axis of the contact blades.

The plug can include a two or more contact blades which protrude into the receptacle, or which traverse the receptacle.

The receptacle can include pairs of opposed slots along a pair of opposed walls through which blades pass.

The receptacle can include a mounting register arrangement to prevent incorrect orientation socket.

The mounting register can include profiled section to prevent incorrect orientation of socket.

The blades can be cantilevered or supported at both ends.

The plane of the blades can be transverse to the insertion direction of the socket into the receptacle.

The housing of the plug can include a slide attachment arrangement adapted to enable the plug to be attached to the edges of an aperture in the wall of its appliance.

Alternatively, the housing of the socket can include such an attachment arrangement.

The contact blades include a cable attachment to which a wire of a cable can be attached.

The contact blades are part of double-ended contact, the other contact being adapted for connexion with an appliance.

The socket includes a connexion protrusion adapted to mate with a receptacle of a plug, and socket contacts adapted to engage with the blades of a plug.

The socket includes contact slots which are adapted to receive plug contact blades.

The leading edges of the slots can be bevelled to facilitate engagement with the blades.

The connexion protrusion is shaped to conform to mounting register of plug receptacle to ensure correct orientation.

The connexion protrusion can have a mating profile to match profile of the receptacle.

The socket contacts can include wire connexion arrangement.

The socket contacts can include spring recess to engage plug blade edge on.

The spring can be formed of a pair of complementary folds.

The connexion protrusion can be transverse to cable orientation.

The socket can include a snap-lock arrangement.

A light fitting can be fitted with, a plug according to an embodiment of the invention.

The light fitting can include an aperture through which the receptacle can be accessed.

The aperture can include cut-outs in a pair of opposed walls, the plug including a slide arrangement adapted to pass through the cut-outs and to engage the edges of the aperture in a sliding manner.

### BRIEF DESCRIPTION OF THE DRAWINGS

An embodiment or embodiments of the present invention will now be described, by way of example only, with reference to the accompanying drawings, in which:

FIG. 1 is a perspective illustration of a socket and plug according to embodiments of the invention;

FIG. 2 is a side illustration of the plug of FIG. 1;

FIG. 3 is an and illustration of the socket of FIG. 1;

FIG. 4A is an illustration of the socket and plug contacts according to an embodiment of the invention;

FIG. 4B is a side view of a spring contact;

FIG. 4C is a side view of a wire connector;

FIG. 5A top view of the socket of FIG. 1 with the cover removed;

FIG. 5b shows detail of the contact slot arrangement of FIG. 5A;

FIG. 6 is a cut away perspective view of a socket and plug (disconnected) with the plug mounted on a wall; and

FIG. 7 is a cut away perspective view of the socket and plug of FIG. 6 (connected) with the plug mounted on a wall.

FIG. 8 illustrates a mounting aperture for a connector in, accordance with an embodiment of the invention.

### DETAILED DESCRIPTION OF THE EMBODIMENT OR EMBODIMENTS

The invention will be described with reference to a connector adapted for use with a multi-wire light fitting adapted to be mounted in a ceiling of a building. The embodiment relates to a five wire connector arrangement. However, it can be used in other applications.

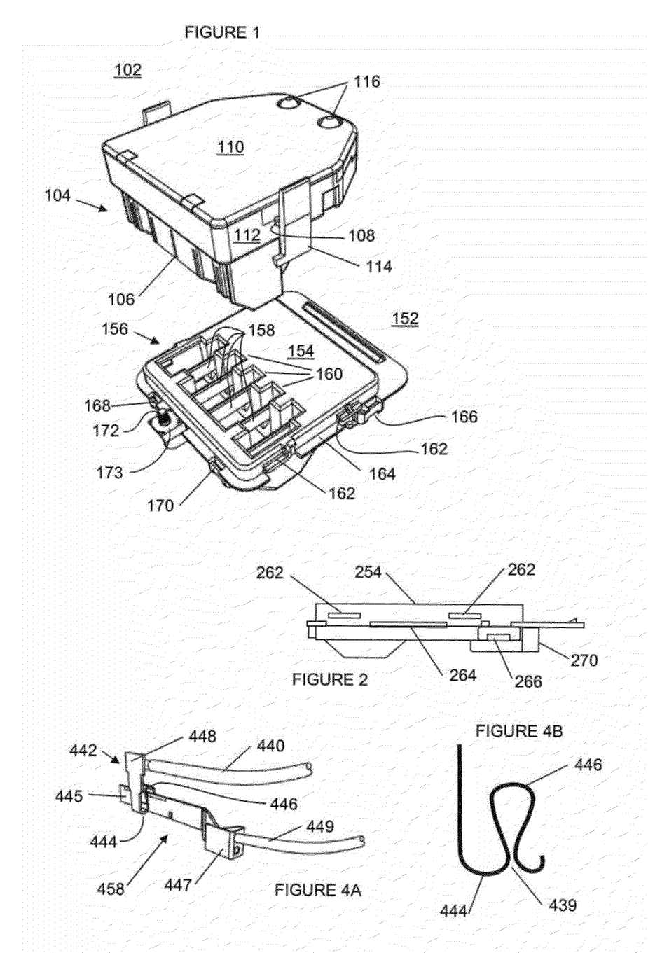

FIG. 1 shows a socket 102 and plug 152 according to respective embodiments of the invention.

The socket 102 has a top cover 110, and a lower housing 112 on which is a socket projection 104 adapted to mate with a receptacle 156 in the plug 152. The socket projection 104 includes several slots 106 adapted to engage contact blades 158 which are partially exposed in the receptacle 156. In this example, there are five plug contact blades 158 and five contact receiving slots 106. A fastening screw or bolt 172 is provided on the plug to enable it to be mounted on an appliance or wall as discussed below. In some instances, there is a need to earth the housing of the appliance. In such cases, an earth tag 173 connected to the earth contact is brought out and fits around the bolt 172 so that, when the bolt is fastened to the housing wall of an appliance, the earth tag 173 is held in electrical contact with the appliance housing.

The socket includes a resiliently mounted releasable clip member 114 which has a catch at its lower end adapted to engage with the latch recess 162 on the plug to retain the socket and plug in engagement.

The socket projection 104 and the receptacle 156 are preferably shaped to permit these components to mate in only one orientation so that each spring contact in the socket connects with the collect blade in the plug. For example, the slots 106 can be off-set so that the blades can only enter the slots when the socket and plug are correctly oriented.

The plane of the plug contacts 158 is substantially upright or transverse to the major plane of the plug 152.

Of course, terms such as upright, vertical, horizontal etc., are used herein in a relative sense using the drawing illustrations as the reference, rather than being referred to absolute references.

While the plane of the plug contacts is illustrated as being substantially vertical, the contact blades could be inclined to the vertical provided the receptacle and mating socket projection were designed to accommodate such a variation. That is, the mating direction of the socket projection 106 with the receptacle 156 is parallel to the plane of the plug contact blades.

Again, it is to be understood that the location of the 158 blades and the slots 106 could be interchanged between the members 102 and 152 without departing from the spirit of the invention.

As shown in FIG. 4A, the socket 102 includes socket contacts 442 which are formed of a suitable conductive resilient material and which are formed to resiliently engage the contact blades 458. The spring contacts in this case have a connexion portion 448 for connecting to a wire 440. This connexion can be by crimping, soldering, welding or other suitable connexion means. To provide the contact pressure to engage the contact blade 458, the spring contact has first and second bends 444, 446 formed in it. As shown in FIG. 48, the spring contact has a contact zone 439 where the free end of the spring contact is close to, or in contact with the main stem of the spring contact when the blade 458 is not inserted. The end of the spring can be formed to provide a diverging opening as shown in the region of the contact zone 447 to facilitate insertion of contact blades.

FIG. 4C is a side view of the wire connector 447 of FIG. 4A. The wire connector includes a triangular shaped arrangement 441, 443, 455, with a wire aperture 451 in the base 443. The side 455 extends beyond the apex 453. The wire connector is made of resilient conductive material, such as phosphor bronze and can be formed integrally with the connector blade 455. The wire 449 passes through the aperture 451 and its free end is captured at the apex 453 where the uninsulated wires are held in spring compression between side 455 and side 441.

The plug blade is also illustrated in FIG. 4A, and includes a substantially rectangular portion 445 adapted to span the receptacle 156 and to seat in slots in the opposed walls of the receptacle. This rectangular portion is also available to engage with the spring contact 442. At one end, the contact blade 458 includes a connexion portion 447 adapted to be connected to a wire 449 by any suitable connexion method. Alternatively, the end 447 may include a further contact element which con engage with a further mating contact of the apparatus.

Either the socket or the plug can be designed to be built into an appliance such as alight fitting. In the example shown in FIG. 1, the plug 152 includes a slide mounting arrangement adapted to engage with the edges of a mounting aperture in an appliance. The mounting arrangement includes a projection 164 and a pair of engaging elements 162 on a pair of opposing sides of the plug. The engaging elements 162 are spaced above the projection 164 by a distance which enables the edge of the wall to fit between in a sliding fit. The projection 164 can be part of a projecting peripheral rim which projects beyond the main body of the plug 152. This arrangement is more clearly illustrated in FIG. 2, in which the engaging elements 262 can be seen as spaced above the projection 264. As shown in FIG. 8, an aperture 882 in a wall of an appliance has cut outs 884 along a pair of opposed sides. The aperture 882 is dimensioned so that the main body of the plug, shown in dashed outline, will pass therethrough, but the projecting rim will not pass through when applied “square” to the aperture 882. The cut outs 884 are located so that the engaging elements 162, 162 can pass through the cutouts. Then the plug can be slid along the aperture in the direction of the arrow so that the engaging elements 262 are no longer aligned with the cut outs 882.

The fixing screw 172 can be accommodated in the slot 886 at one end of the aperture 882 and the plug can be fixed in position in the aperture 882 using the screw 172.

FIG. 2 also shows a side view of a connector 270 via which connexion can be made to the circuitry of the apparatus to which the plug is attached.

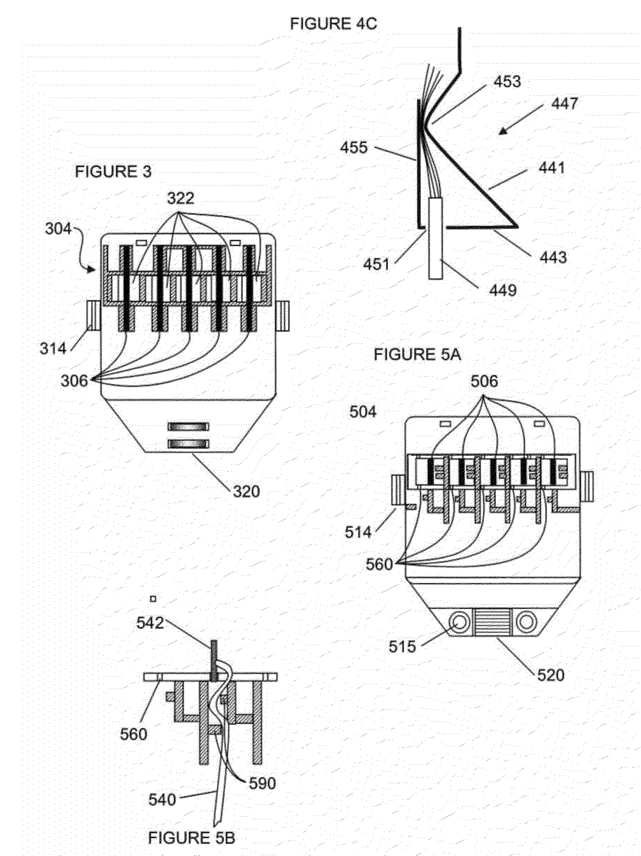

FIG. 3 is an illustration of the main features of the underside of the socket the socket projection 306 has a plurality of slots 322 adapted to receive the contact blades from a mating plug. Each slot passes through a contact isolation box 322 which is open ended at its distal end remote from the body of the socket. The resilient clip arrangement 314 can also be seen.

FIG. 5 is a top view of the socket with the cover 110 removed. Slots 506 are visible through upper isolation boxes which are separated form the lower isolation boxes 322 by a “party wall”, i.e., a common wall. Retaining slots 560 in opposed walls of the isolation boxes are adapted to receive the upper portion of the spring contacts (see 442 in FIG. 4). These retaining slots are only of sufficient depth to hold the spring contacts and thus serve to prevent the spring contacts from being pulled through the socket when disengaging force is applied. Strain relief isolating the connexion between the contacts 542 and the wire 540 can also be provided by a “meander” path provided by one or more projections 590.

A cable clamping aperture 520 is adapted to receive a cable and hold it under compression due to the fastening screws 116 (FIG. 1) as they are tightened in the corresponding screw holes 515. Preferable the aperture 520 includes a raised friction enhancing pattern on its surface.

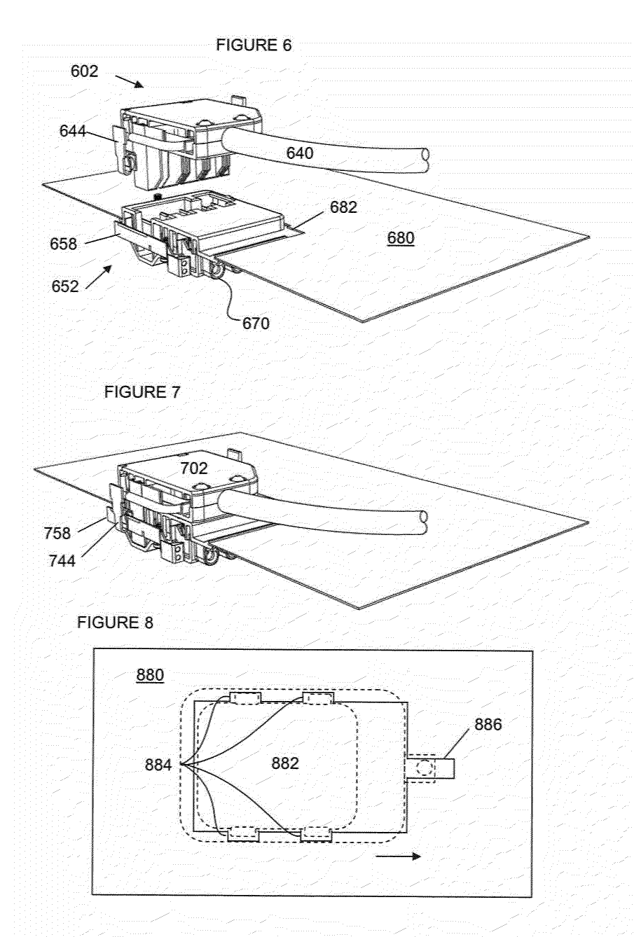

FIGS. 6 & 7 illustrate cutaway views of the socket and plug in the disconnected and connected state respectively, with the plug mounted on a wall 680 through aperture 682. A spring contact 644 is shown on the socket 602, and a blade contact 658 is shown on the plug 652. In FIG. 7, the spring contact 744 and the blade contact, 758 are shown in engagement.

As seen in FIG. 6, the mounting arrangement and the design of the plug provide a low profile mounting arrangement, the minimum limit of which is the height of the engaging elements 262 or the mounting screw.

The connector arrangement provides a connector in which the insertion direction is substantially transverse to the main axial direction of the contact blades. In addition the insertion/removal direction is substantially transverse to the cable axis of the cable inserted into the socket.

Where ever it is used, the word “comprising” is to be understood in its “open” sense, that is, in the sense of “including”, and thus not limited to its “closed” sense, that is the sense of “consisting only of”. A corresponding meaning is to be attributed to the corresponding words “comprise”, “comprised” and “comprises” where they appear.

It will be understood that the invention disclosed and defined herein extends to all alternative combinations of two or more of the individual features mentioned or evident from the text. All of these different combinations constitute various alternative aspects of the invention.

While particular embodiments of this invention have been described, it will be, evident to those skilled in the art that the present invention may be embodied in other specific forms without departing from the essential characteristics thereof. The present embodiments and examples are therefore to be considered in all respects as illustrative and not restrictive, and all modifications which would be obvious to those skilled in the art are therefore intended to be embraced therein.

1. A plug having a receptacle adapted to mate with socket contacts, the receptacle including contact blades being adapted to engage with socket contacts inserted transverse to the axis of the contact blades.

2. A plug as claimed in claim 1, including one or more contact blades which protrude into the receptacle, or which traverse the receptacle.

3. A plug as claimed in claim 1 or claim 2, wherein the receptacle includes pairs of opposed slots along a pair of opposed walls through which blades pass and are supported therein.

4. A plug as claimed in any one of the preceding claims, wherein the receptacle includes a mounting register arrangement to prevent incorrect orientation of socket.

5. A plug as claimed in claim 4, wherein the mounting register includes a profiled section to prevent incorrect orientation of socket.

6. A plug as claimed in any one of the preceding claims, wherein the plane of the blades is parallel to the insertion direction of the socket into the receptacle.

7. A plug as claimed in any one of the preceding claims, wherein the plane of the blades is transverse to the major plane of the plug.

8. A plug as claimed in any one of the preceding claims, wherein the housing of the plug includes a slide attachment arrangement adapted to enable the plug to be attached to the edges of an aperture in a wall.

9. A plug as claimed in any one of the preceding claims, wherein the contact blades include a cable attachment to which a wire of a cable can be attached.

10. A plug as claimed in any one of the preceding claims, wherein the contact blades are part of double-ended contact, the other contact being adapted for connexion with the circuitry of an appliance.

11. A socket including a connexion protrusion adapted to mate with a receptacle of a plug, and socket contacts adapted to engage with the blades of a plug.

12. A socket as claimed in claim 11, including contact slots which are adapted to receive plug contact blades.

13. A socket as claimed in claim 11 or claim 12, wherein the connexion protrusion is shaped to conform to mounting register of plug receptacle to ensure Correct orientation.

14. A socket as claimed in any one of claims 11 to 13, wherein the connexion protrusion has mating profile to, match profile of receptacle.

15. A socket as claimed in any one of claims 11 to 14, wherein the socket contacts include spring recess to engage plug blade.

16. A socket as claimed in claim 15, wherein the spring is formed of a pair of complementary folds.

17. A socket as claimed, in any one of claims 11 to 16, wherein the connexion protrusion is transverse to cable axis.

18. A socket as claimed in any one of claims 11 to 17, including a snap-lock arrangement.

19. An electrical contact blade having an elongate shape in which the major axis of the contact blade is transverse to the plugging direction.

20. An electrical spring contact including a spring recess adapted to grip a contact blade as claimed in claim 19.

21. A plug including a receptacle adapted to house one or more contact blades as claimed in claim 19.

22. A plug as claimed in claim 21, wherein the receptacle is adapted to engage with a socket as claimed in claim 20.

23. A socket including a contact housing adapted to house one or more spring contacts as claimed in claim 20.

24. A socket as claimed in claim 23, wherein the contact housing is adapted to engage with a receptacle of a plug as claimed in claim 21 or claim 22.

25. An electrical appliance including a plug as claimed in any one of claims 1 to 10.

26. An electrical appliance as claimed in claim 25, including an aperture through which the receptacle can be accessed.

27. An electrical appliance as claimed in claim 25 or claim 26, wherein the aperture includes cut-outs in a pair of opposed walls, the plug including a slide arrangement adapted to pass through the cut-outs and to engage the edges of the aperture in a sliding manner.

28. An electrical appliance as claimed in any one of claims 25 to 27, wherein the plug includes an external earth contact adapted to contact the housing of the appliance, the earth contact being connected to an earth contact of the connector.

29. A plug substantially as herein described with reference to the accompanying drawings.

30. A socket substantially as herein described with reference to the accompanying drawings.
